(19) United States
(12) Patent Application Publication
(10) Pub. No.: US 2007/0279000 A1
(43) Pub. Date: Dec. 6, 2007

(54) Plug in power adapter and/or battery pack for cordless tools

(76) Inventor: Carlos E. Lucero, Albuquerque, NM (US)

Correspondence Address: SUNG I. OH, PROFESSIONAL LAW CORPORATION, 710 QUAIL VALLEY LANE, WEST COVINA, CA, 91791, US

(21) Appl. No.: 11/444,234

(22) Filed: May 30, 2006

(51) Int. Cl. H02J 7/00

(52) U.S. Cl. 320/112

(57) ABSTRACT

A plug-in battery pack is adapted to transfer utility power to a power tool in the event the batteries of the power tool die or otherwise become insufficient to operate the tool. The battery pack includes a transformer which transforms utility power into a form that is suitable for use by a power tool that is normally powered by a battery.

### TECHNICAL FIELD OF THE INVENTION

The present invention relates to the general art of power tools, and to the particular field of cordless power tools.

### BACKGROUND OF THE INVENTION

Electrically operated devices that function in a cordless mode typically include a housing which has a chamber for receiving and retaining a removable battery pack. The battery pack completely encloses one or more cells and provides the necessary DC power for operation of the device. Historically, cordless electrically powered devices have included relatively low power devices such as shavers and hand-held calculators. Recently, improvements in battery technology have led to the development of batteries that store more energy and are capable of driving higher power devices. These devices include for example, portable hand-held power tools and appliances operating at power levels from 50 watts up to hundreds of watts. A hand-held power tool is typically powered by a battery pack that comprises a number of batteries connected in series. To provide the higher power levels required by high power devices an increased number of batteries are connected in series resulting in higher input voltages and battery pack volumetric requirements.

Cordless power devices permit work operations to be performed in areas where a conventional AC power source is not available or inconvenient to use. However, the effective charge capacity of the battery pack and the availability of replacement battery packs limit the use of cordless devices. When the battery pack is discharged, it must be recharged or replaced with a fully charged pack.

Both batteries and battery chargers are expensive in comparison to the power device for which they are intended. Batteries for high power applications cost approximately 30% of the cost of the applicable power device. Additional batteries are required to permit cordless mode operation while a battery is recharged and to replace dead batteries. High power levels drawn from batteries during operation of the power tool, the depth of discharge of the battery, the number of charge/discharge cycles, and the speed with which a battery is recharged all contribute to shortening the usable lifetime of a battery. Fast chargers can cost more than the power tool or appliance that is powered by the battery. There are two basic types of battery chargers, trickle chargers and fast chargers. Trickle chargers are significantly less expensive than fast chargers, however a trickle charger requires approximately ½ day to recharge a battery pack. A fast charger on the other hand can recharge a battery pack within approximately one hour. Therefore, a trade off must be made between using a trickle charger with a large number of battery packs versus using a costly fast charger with very few replacement battery packs

Still, cordless power tools have become increasingly more popular. One reason for the increase in popularity relates to improvements which have been made with respect to battery pack designs. Contemporary battery packs provide cordless power tools with power capabilities that rival corded models. Additionally, contemporary battery packs typically can be used for extended periods without requiring recharging.

One type of conventional rechargeable electric power tool incorporates a detachable battery pack mounted in the lower end of the handle thereof. When the battery pack needs to be recharged, it is detached from the handle of the tool and set on a separate charger. After the charging is completed, the battery pack is mounted back in the handle to resume operation. If an electric power tool operating on a detachable battery pack is used for extended periods of time an auxiliary battery pack can be set in a charger for recharging. When the pack mounted in the tool is discharged, the operator replaces it with the one that has been recharged by the charger and sets the discharged battery pack on the charger for recharging. This works well if the user remembers to plug the auxiliary battery in and the auxiliary battery is in a location convenient to the worker when the power in the tool becomes depleted.

Battery packs used for the above-described purpose are generally designed to maximize their capacity and thus the operating time of the tool per charge. This tends to increase the size and weight of the packs, which in turn places an excessive physical strain on the operator and reduces the operability of the tools and work efficiency. This tendency is particularly pronounced when such large and heavy battery packs are used for an extended period of time or the tool must be used in an awkward location; the operability of the tools may be severely affected so as to significantly reduce the productivity. In addition, loss of time in the process of replacing discharged battery packs has been a significant factor that reduces work efficiency.

Moreover, chargers used for such battery packs continue to supply charging current, even after the battery packs are charged to the full, therefore placing the batteries or cells in the pack under heavy load and reducing the charge efficiency. In addition, this results in a waste of power.

### SUMMARY OF THE INVENTION

The above-discussed disadvantages of the prior art are overcome by a plug-in battery pack that is adapted to transfer utility power to a power tool in the event the batteries of the power tool die or otherwise become insufficient to operate the tool. The battery pack includes a transformer which transforms utility power into a form that is suitable for use by a power tool that is normally powered by a battery.

Using the plug-in battery pack embodying the present invention will permit a power tool user to continue using a battery-powered tool even if the battery becomes insufficient to power the tool. The user need not find a suitable outlet to recharge the tool battery and need not wait for such recharging to be completed.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a plug-in battery pack embodying the present invention.

FIG. 2 is an end elevational view of the plug-in battery and/or power adapter pack shown in FIG. 1.

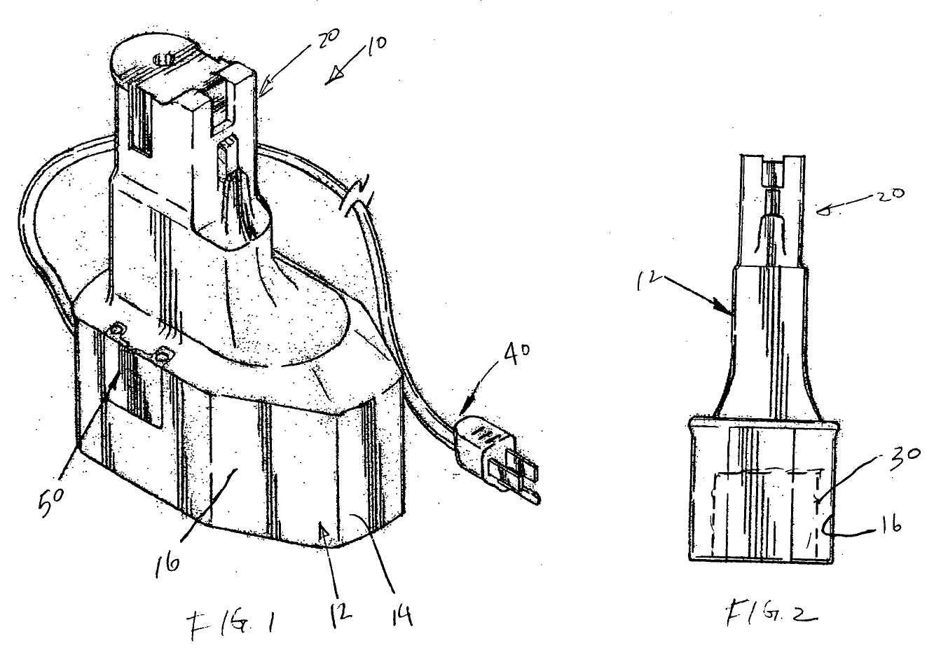

### DETAILED DESCRIPTION OF THE INVENTION

Referring to the figures, it can be understood that the present invention is embodied in a plug-in battery pack and/or power adapter 10 for use with a battery-powered tool, such as a power drill or the like. Battery pack and/or power adapter 10 comprises a housing 12 which has a base 14. Base 14 is hollow and has an internal chamber 16 therein.

A tool mount 20 is positioned on the base. The tool mount is sized and shaped to couple with a battery coupling system of a battery-powered power tool. The exact details of the size and shape of mount 20 are not important and will not be discussed or claimed. It is only noted that mount 20 has positive and negative contacts as well as a ground and suitable mechanical locks that are associated with power tools as will be understood by those skilled in the art.

A transformer 30 is located in internal chamber 16. The transformer is adapted to transform utility power to power suitable for use by a battery-powered power tool. Again, the circuitry and the details thereof associated with such a transformer are well known and will not be discussed or claimed. This circuitry can, for example, transform 120 volt, 60 cycle power to 12 volt dc power at 1000-2000 milliamps.

A power cord 40 electrically connects the transformer to a source of utility power. A battery charging system 50 can be located on the base. Battery charging system 50 is electrically connected to the transformer to apply power to rechargeable batteries located in the battery charging system.

Use of system 10 can be understood from the teaching of this disclosure and thus will only be briefly discussed. During use of a battery-powered tool, should the battery of that tool deplete to a level insufficient to operate the tool, the tool is simply applied to mount 20 in the manner that would recharge the battery of the tool. Charger 10 is plugged into a source of utility power, such as a wall outlet, and the utility power will be applied to the tool in place of the battery of the tool. The tool can then be operated in the usual manner. If a battery charging system is included, the batteries from the tool can be placed in that recharging system for recharging during use of the tool. Alternatively, batteries can be stored in the recharging system for use in the event the batteries of the tool run down.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A plug-in battery pack for use with a battery-powered tool comprising:
A) a housing, the housing having
(1) a base,
(2) an internal chamber in the base, and
(3) a tool mount on the base, the tool mount being sized and shaped to couple with a battery coupling system of a battery-powered power tool;
B) a transformer in the internal chamber, the transformer being adapted to transform utility power to power suitable for use by a battery-powered power tool; and
C) a power cord for connecting the transformer to a source of utility power.

2. The plug-in battery pack defined in claim 1 further including a battery charging system on the base, the battery charging system being connected to the transformer to apply power to rechargeable batteries located in the battery charging system.
